(19) United States
(12) Patent Application Publication
(10) Pub. No.: US 2007/0104165 A1
(43) Pub. Date: May 10, 2007

(54) MIMO system with plural access points

(75) Inventors: Seishi Hanaoka, Tokyo (JP); Takashi Yano, Tokorozawa (JP); Satoshi Tamaki, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi Communications Technologies, Ltd.

(21) Appl. No.: 11/501,045

(22) Filed: Aug. 9, 2006

(30) Foreign Application Priority Data
Nov. 9, 2005 (JP) 2005-324280

(51) Int. Cl. H04Q 7/24

(52) U.S. Cl. 370/338

(57) ABSTRACT

A prior art MIMO technique assumes one-to-one communication in which a transmitter and a receiver exist and does not assume a cellular system in which plural access points and access terminals exist. When the prior art is applied to the cellular system, the characteristic can be deteriorated. MIMO signal processing is not performed in access points. Signal processing units in the access points are integrated into an access point controller controlling plural access points and the MIMO signal processing for plural access points is performed together.

### CLAIM OF PRIORITY

The present application claims priority from Japanese application JP 2005-324280 filed on Nov. 9, 2005, the content of which is hereby incorporated by reference into this application.

### FIELD OF THE INVENTION

The present invention relates particularly to a MIMO method for improving spectral efficiency in a modulator/demodulator used in a wireless communication system.

### BACKGROUND OF THE INVENTION

One of methods for improving spectral efficiency in a wireless communication system is MIMO (multi input multi output). As introduced in WOLNIANSKY, P. W., et al.: “V-BLAST: An architecture for realizing very high data rates over the rich-scattering wireless channel”. Proc. IEEE ISSSE-98 (1998/09), MIMO is a technique of performing high-speed data communication having high spectral efficiency by transmitting different data signals at the same frequency from plural transmission antennas to receive and restore the same by plural reception antennas. A concept view of MIMO is shown in FIG. 1 and will be specifically described. A transmitter (101) receives user data from an information source (network side), not shown, and performs coding by a coding function included in the transmitter (101). The coded data generated by coding is divided into information for the number of antennas to be transmitted from plural antennas (103). A division function, not shown, is included in the transmitter. The divided signals are inputted to the plural antennas (103) to be transmitted from the antennas (103) into the air. For simplifying the description, a radio frequency unit (RF unit) having a mixer, a filter, and an amplifier is omitted in this drawing. The omitted RF unit modulates the generated baseband signal transmitted from each of the antennas. The signal is subjected to D/A conversion and radio frequency conversion included in the RF unit to be converted to information at radio frequency transmittable from the antennas. The feature of the MIMO technique is that signals transmitted from the antennas are different from each other. By this feature, a receiver can separate reception signals from the antennas by a matrix operation and permits transmission having high transmission efficiency and securing of a propagation path having high reliability. Various methods of dividing information to antennas have been known. For instance, there have been known techniques of a simple space time block code (STBC) inserting a delay device into one of two antennas and BLAST (bell labs layered space-time) merged with the coding function to perform space coding.

Such MIMO system has one transmitter (101) and one receiver (102) corresponding thereto and is one of transmission methods defined between the transmitter (101) and the receiver (102). A wireless LAN in which plural access terminals are accommodated in one access point employs, as an access method, CSMA/CA (carrier sense multiple access collision avoidance). The plural access terminals cannot communicate with the access point at the same time. The wireless LAN can be interpreted as a prior art MIMO system having one transmitter (101) and one receiver (102) corresponding thereto. The wireless LAN is also often used in an isolated state in a relatively small area in an office.

A MIMO system applied to a cellular system typified by a cellular phone is as shown in FIG. 2. It is greatly different from the prior art in that plural access terminals can communicate with an access point at the same time and that plural access points are located to cover a wide area.

The cellular system has an access terminal (202), an access point (203) communicating with the access terminal, and an access point controller (204) controlling and accommodating plural access points, and communicates with other party via the access point controller (204). When the MIMO technique is performed on the down line for transmission, the access point (203) is a transmitter and the access terminal (202) is a receiver.

The MIMO technique is one of techniques of improving spectral efficiency in a wireless section. Signal processing for realizing MIMO is added to both the access point and the access terminal. The cellular system has, in addition to the access point and the access terminal, the access point controller as a host station of the access points. Information in the wireless section is terminated on the access point and the access terminal. The access point controller requires function correction and addition for realizing MIMO. [Patent document 1] JP-A No. 2003-244050

### SUMMARY OF THE INVENTION

When MIMO is applied to a cellular system, plural access points are generally arranged as shown in FIGS. 2 and 3 to secure a wide service area. When the access points having the MIMO technique perform transmission independently, the throughput can be lowered. This reason will be explained using FIGS. 2 and 3.

When, on the down line, the access point transmits an electric wave and the access terminal receives it, the electric wave is attenuated according to the distance from the access point to the access terminal to reach the access terminal. The attenuation degree is different depending on indoor and outdoor propagation environments. The electric wave is attenuated in proportion to the second to fourth power of the distance. Multi-pass fading in addition to the range attenuation fluctuates the reception level of the electric wave reaching the access terminal. When the distance between the access point and the access terminal is short, the range attenuation is small in many cases. As shown in FIG. 2, the access terminal communicates with one access point closest thereto. The influence of the electric wave from the other access point is relatively small.

As shown in FIG. 3, when the access terminal is far from the access point, the range attenuation is large and an electric wave (302) from an access point #1 is weak so as to be susceptible to an electric wave (303) from the uncommunicated access point (in this example, an access point #2). The throughput is difficult to improve when the MIMO technique is used for transmission.

When the access terminal is far from the access point, in order to improve the throughput and reception quality, the cellular system uses a soft handover technique in which identical signals are transmitted from plural access points on the down line to be combined by the access terminal to improve the reception characteristic. The soft handover technique assumes that identical signals are transmitted from the access point #1 and the access point #2. When the MIMO technique in which the access point #1 and the access point #2 are independent from each other is used for performing data transmission, the signals from the access points are different from each other and cannot be easily combined. When they cannot be combined properly, the mixed signals can increase an interference electric power. The throughput characteristic can be deteriorated.

When MIMO is applied to the cellular system, the access points need be controlled in conjunction with each other.

To solve the above problems, the MIMO signal processing functions in the access points are integrated into the access point controller controlling plural access points or a host device of the access points to perform MIMO signal processing for plural access points together.

In addition, to solve the above problems, signal processing necessary for MIMO is added to RoF (Radio on Fiber) The present invention can perform MIMO using plural antennas located physically apart from each other and can perform communication having high spectral efficiency when the access point and the access terminal are far from each other in the cellular system (or at a cell boundary).

Not only the MIMO signal processing, but also baseband units themselves for processing radio signals, are integrated into one place. A flexible combination of plural antennas is enabled. As the entire system, a MIMO system not depending on the places of located antennas can be realized.

The baseband units themselves for processing radio signals are integrated into one place. The fault tolerance and maintenance can be improved to any fault in hardware and software realizing the signal processing units and the cost of the system can be reduced.

### BRIEF DESCRIPTION OF THE DRAWINGS

FIG. 1 is a concept view of MIMO;

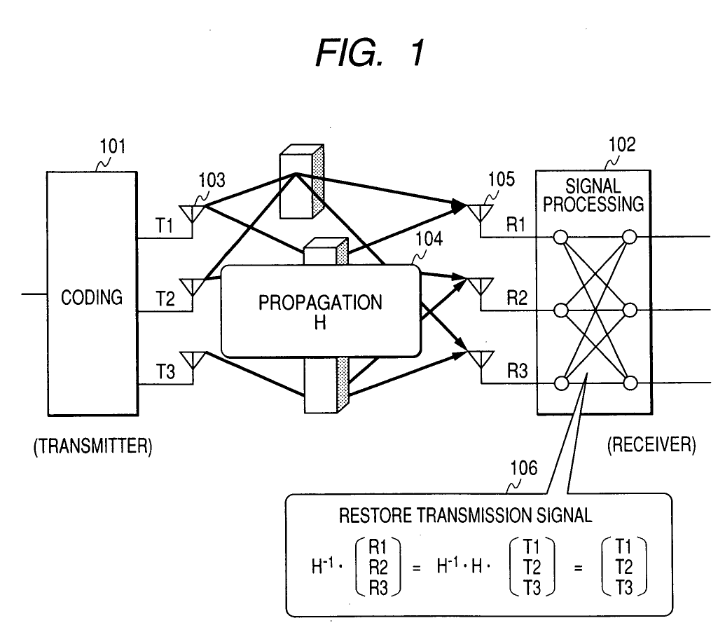

FIG. 2 is a block diagram of a MIMO system applied to a cellular system;

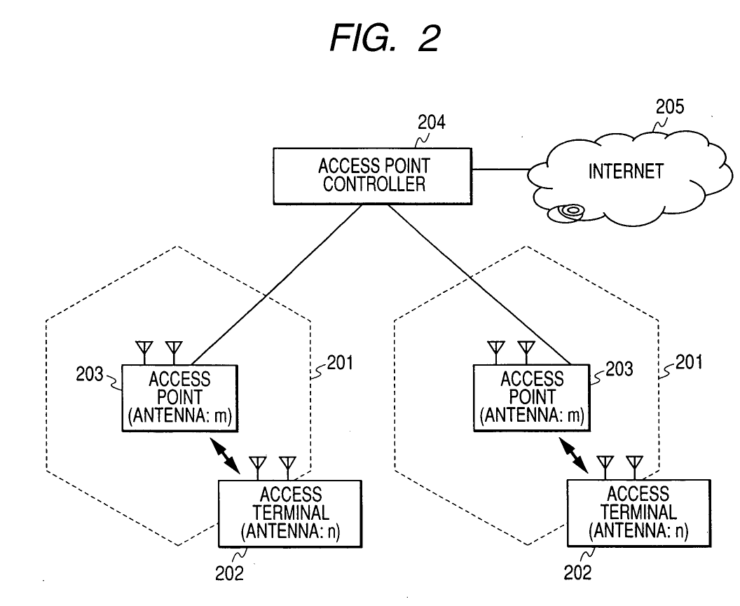

FIG. 3 is a diagram showing the problem of a prior art MIMO system applied to a cellular system;

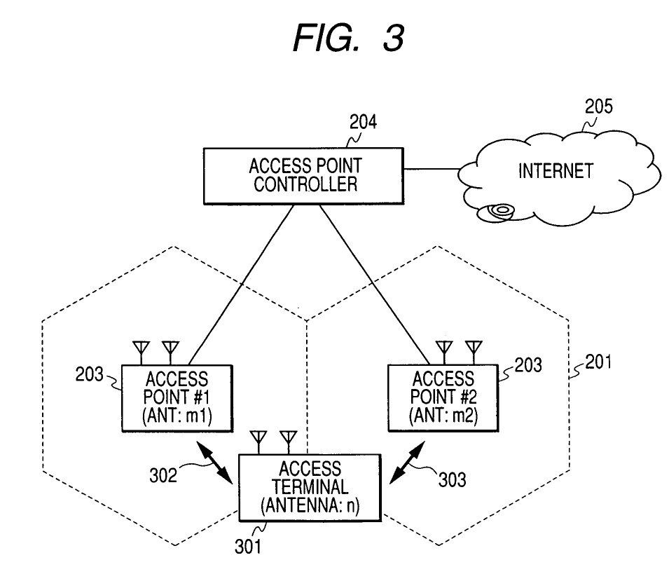

FIG. 4 is a block diagram of a MIMO system according to the present invention using plural pieces of antenna equipment located apart from each other;

FIG. 5 is a diagram of the configuration of the MIMO system according to the present invention;

FIG. 6 is a diagram showing an example of signal sequences transmitted from plural pieces of antenna equipment according to the present invention;

FIG. 7 is a diagram showing another example of signal sequences transmitted from plural pieces of antenna equipment according to the present invention;

FIG. 8 is a block diagram of a transmitter of an access point according to the present invention;

FIG. 9 is a block diagram of another transmitter of an access point according to the present invention;

FIG. 10 is a block diagram of a receiver of an access point according to the present invention;

FIG. 11 is a block diagram of another receiver of an access point according to the present invention;

FIG. 12 is a diagram showing hierarchical structures of an access point and an access point controller according to the present invention;

FIG. 13 is a diagram showing a down line MIMO control flow at reception on an access terminal according to the present invention;

FIG. 14 is a diagram showing a down line MIMO control flow at transmission on an access terminal according to the present invention;

FIG. 15 is a diagram showing an up line MIMO control flow at reception on an access terminal according to the present invention; and

FIG. 16 is a diagram showing an up line MIMO control flow at transmission on an access terminal according to the present invention.

### DETAILED DESCRIPTION OF THE PREFERRED EMBODIMENTS

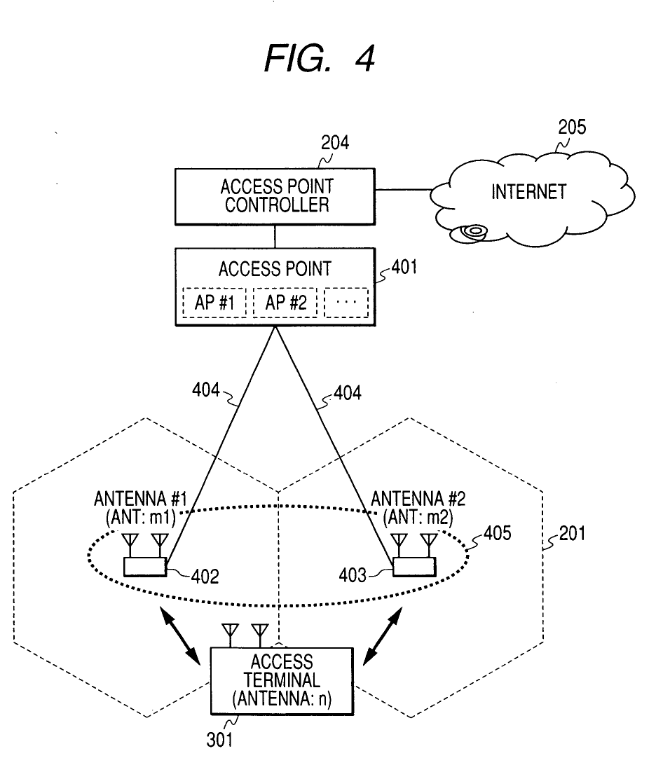

The prior art access point (203) has a transmission unit (a unit performing processing corresponding to the reference numeral (101) on the down line, the transmission antennas (103), the reception antennas (105), and a reception unit (a unit performing processing corresponding to the reference numeral (102) on the up line. As shown in FIG. 4, the transmission antennas (103) and the reception antennas (105) are physically separated from the transmission unit and the reception unit performing coding of the prior art access points (203) to be antenna equipment (402) and antenna equipment (403). Only the antenna equipment (402) and the antenna equipment (403) are located in the places in which the prior art access points are located. Other functions of the transmission unit and the reception unit are integrated into one place of the prior art access point controller (204) controlling plural access points to be an access point (401) in the present invention. The antenna equipment (402) and the antenna equipment (403) have plural antennas, respectively.

As in the prior art, the access point (401) is connected to the access point controller (204) as a host station and is connected to other party via the access point controller.

The antenna equipment (402) and the antenna equipment (403) are connected to the access point (401) in the present invention using a cable such a copper wire and an optical fiber or a high-speed wireless channel such as an FWA (fixed wireless access) method using a millimeter wave, thereby transmitting a user data sequence from an information source and a control signal for controlling the antenna equipment (402) and the antenna equipment (403) located in the respective places. Various communication methods between the access point (401) and the antenna equipment (402) and the antenna equipment (403) are considered. There needs management such as securing a band in which a control signal for controlling the antennas is used to be reached at control time and ensuring of time to transmit and receive an originator control signal.

Signal transmission processing on the down line will be specifically described.

The access point (401) receives user data from an information source via the Internet (205) and the access point controller (204) to perform coding by the coding unit included in the access point (401). In order to realize MIMO, the coded data generated by coding is divided into information for the number of antennas to be transmitted from the plural pieces of antenna equipment (402, 403). The division function, not shown, is included in the access point (401). The divided signals are inputted to the antenna equipment (402) and the antenna equipment (403) located in plural places connected using a cable such as a copper wire and an optical fiber or a high-speed wireless channel such as an FWA (fixed wireless access) method using a millimeter wave and are transmitted into the air from the antennas of the antenna equipment (402) and the antenna equipment (403). For simplifying the description, a radio frequency unit (RF unit) having a mixer, a filter, and an amplifier is omitted in this drawing. The omitted RF unit modulates the generated baseband signal transmitted from each of the antennas. The signal is subjected to D/A conversion and radio frequency conversion included in the RF unit to be converted to information at radio frequency transmittable from the antennas. The RF unit may be included in the antenna equipment (402) and the antenna equipment (403) or the access point (401).

An access terminal (301) receives electric waves using plural antennas to convert them to baseband signals via the RF unit having a mixer, a filter, an amplifier, and an A/D converter. For simplifying the description, the RF unit is omitted in this drawing. The baseband signals received by the antennas are separated by a matrix operation to restore the MIMO information. Seen from the access terminal (301), it is important that the signals transmitted from the antennas be different from each other, which is the feature of the MIMO technique. It is unnecessary to be conscious of whether they are transmitted from the antenna equipment (402) and the antenna equipment (403) located physically apart from each other. The access terminal need not identify from which access point a signal is transmitted. As shown in the reference numeral (405), when the antenna equipment (402) and the antenna equipment (403) are located apart from each other, plural access points can be interpreted as one access point having antennas in plural places located physically apart from each other.

It has been generally known that antennas located apart from each other by a half-wavelength or more of radio frequency transmitted into the air are in substantially non-correlation. When plural antennas are located for diversity on the transmission side and plural antennas are located for reception diversity on the reception side, they are generally located apart from each other by a half-wavelength or more. It is most important that they be in non-correlation. The present invention is not limited to a half-wavelength.

In view of the inside of one piece of antenna equipment (402 or 403) in the present invention, plural antennas are located apart from each other by a half-wavelength or more. The antenna equipment (402) and the antenna equipment (403) are located in ”places physically apart from each other”, which does not refer to the length of about a half-wavelength (at most about several meters), but refers to the length of about several hundred meters to several kilometers in such a manner that the access points of the cellular system in the prior art are located in cells, respectively.

In the present invention, MIMO signals are transmitted from the antenna equipment #1 (402) and the antenna equipment #2 (403) on the down line (communication from the access point toward the access terminal).

Signal transmission processing on the up line will be specifically described.

The access terminal (301) subjects coding to transmitted data from the user having the access terminal by the coding unit included in the access terminal (301). In order to realize MIMO, the coded data generated by coding is divided into information for the number of antennas to be transmitted from the plural pieces of antenna equipment of the access terminal (301). The division function, not shown, is included in the access terminal (301). The divided signals are transmitted into the air from the plural antennas of the access terminal (301). For simplifying the description, a radio frequency unit (RF unit) having a mixer, a filter, and an amplifier is omitted in this drawing. The omitted RF unit modulates the generated baseband signal transmitted from each of the antennas. The signal is subjected to D/A conversion and radio frequency conversion included in the RF unit to be converted to information at radio frequency transmittable from the antennas.

The antenna equipment (402) and the antenna equipment (403) receive electric waves from the antennas to convert them to baseband signals via the RF unit having a mixer, a filter, an amplifier, and an A/D converter. For simplifying the description, the RF unit is omitted in this drawing. The baseband signals received by the antennas are transmitted to the access point (401) subjected to connection (404) using a cable such as a copper wire and an optical fiber or a high-speed wireless channel such as an FWA (fixed wireless access) method using a millimeter wave. The baseband signals received by the access point (401) are separated by a matrix operation to restore the MIMO information. Seen from the access point (401), it is important that the signals transmitted from the antennas be different from each other, which is the feature of the MIMO technique. It is unnecessary to be conscious of whether they are received by the antennas located physically apart from each other. The access point need not identify from which access equipment a signal is received. As shown in the reference numeral (405), plural pieces of antenna equipment can be interpreted as plural antennas of one access point (401).

It has been generally known that antennas located apart from each other by a half-wavelength or more of radio frequency transmitted into the air are in substantially non-correlation. When plural antennas are located for diversity on the transmission side and plural antennas are located for reception diversity on the reception side, they are generally located apart from each other by a half-wavelength or more. It is most important that they be in non-correlation. The present invention is not limited to a half-wavelength.

In view of the inside of one piece of antenna equipment (402 or 403) in the present invention, plural antennas are located apart from each other by a half-wavelength or more. The antenna equipment (402) and the antenna equipment (403) are located in “places physically apart from each other”, which does not refer to the length of about a half-wavelength (at most about several meters), but refers to the length of about several hundred meters to several kilometers in such a manner that the access points of the cellular system in the prior art are located, respectively.

Handover such as change of a service area according to movement of the access terminal is reflected by weight (directivity and electric power control) of data sequences transmitted from the antennas in MIMO.

In the present invention, plural pieces of antenna equipment located physically apart from each other function as plural transmission/reception antennas located physically apart from each other in MIMO. The antennas located physically apart from each other are used so that propagation paths between the respective pieces of antenna equipment and the access terminal are assumed to be independent and to be in non-correlation. It is possible to obtain a diversity effect in which when the status of the propagation path of one piece of antenna equipment is deteriorated, communication from the other piece of antenna equipment can be performed.

In the present invention, prior art processing for plural access points is integrated into the access point (401). Switching of plural accommodated access points which has been necessary in the access point controller (204) can be unnecessary or simplified. Whether or not plural access points need to be switched in the access point controller depends on the number of the access points (401) accommodated in the access point controller and the number of connections which can be processed by the access points (401) at the same time. For instance, when assuming the specification in which one access point controller (204) accommodates 1000 users and one access point (401) permits processing for 1000 users, switching of the access points is unnecessary. When one access point (401) permits processing for up to 100 users, ten access points (401) need to be prepared. In this case, switching of the access points (401) to be connected is necessary in the access point controller (204).

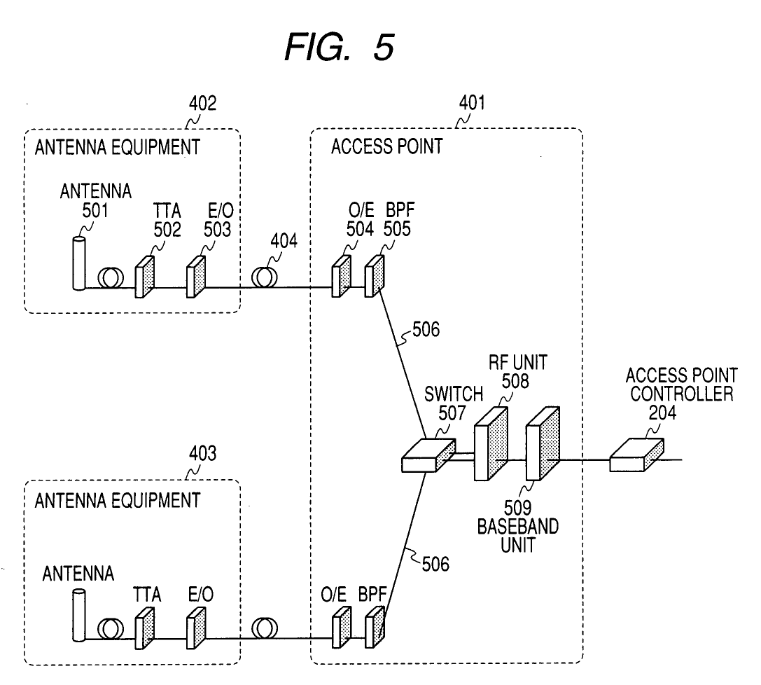

The system configuration in the present invention is shown in FIG. 5. FIG. 5 shows the system configuration of portions corresponding to the antenna equipment (402), the antenna equipment (403), and the access point (401) of FIG. 4.

The antenna equipment (402 or 403) in the present invention has an antenna (501), a tower top antenna (502), and an optical/electrical (O/E) converter and an electrical/optical (E/O) converter (503). Here, the O/E converter refers to a device converting an optical signal to an electric signal, and the E/O converter refers to a device converting an electric signal to an optical signal. When data is transmitted from the access point (401) to the access terminal (301), an optical signal transmitted to the antenna equipment (402) and the antenna equipment (403) via an optical fiber needs to be converted to an electric signal for propagating the optical signal into the air. The O/E converter is thus used. When an electric wave from the access terminal (301) is received by the access point, an electric signal received by the antenna (501) needs to be converted to an optical signal. The E/O converter is thus used. The antenna equipment (402) and the antenna equipment (403) are connected to the access point (401) via an optical fiber.

The access point has an O/E converter and an E/O converter (504), a band pass filter (BPF) (505), a switch (507) switching signals between the respective pieces of antenna equipment, a radio frequency unit (RF unit) (508), and a baseband unit (509). When data is transmitted from the access point (401) to the access terminal (301), an electric signal to be transmitted which has been generated by the access point needs to be converted to an optical signal to be transmitted to the antenna equipment (402) and the antenna equipment (403) via an optical fiber. The E/O converter is thus used. When an electric wave from the access terminal (301) is received by the access point, an optical signal needs to be converted to an electric signal processable by the access point. The O/E converter is thus used. The band pass filter is located for removing noise in an excess band after completion of O/E conversion to take out only a signal component in a desired band. The example of FIG. 5 assumes to respond to use of frequency different for each user and use of frequency different depending on the transmission directions (up line/down line). The RF unit (508) having a mixer, a filter, and an amplifier modulates baseband signals to be transmitted from the antennas at transmission on the down line. The signals are subjected to D/A conversion and radio frequency conversion to be converted to information at radio frequency transmittable from the antennas. The RF unit converts radio frequency to baseband signals at reception on the up line and performs A/D conversion to the baseband signals received by the antennas.

The baseband unit (509) receives user data from an information source via the access point controller (204) at transmission on the down line to perform coding. The coded data generated by coding is divided into information for the number of antennas to be transmitted from the plural antennas (103). The division function is performed by the baseband unit (509). In order that the access terminal (301) can estimate the status of a wireless propagation path, the baseband unit (509) includes the function of generating and transmitting a known training sequence as a system matched with each divided signal. At reception on the up line, the baseband signals received by the antennas are subjected to a matrix operation to restore the MIMO data. Estimation of a wireless propagation path and detection of a received signal are performed by the baseband unit.

The flow of data on the down line will be described. Data to be transmitted via the access point controller (204) is inputted to the access point (401). The baseband unit (509) performs coding and modulation. The RF unit (508) converts the baseband signals to radio frequency. The number of the baseband units (509) and the number of the RF units (508) so as to process plural users are necessary. They are integrated into one place as the location place of the access point (401) in the present invention. When a double configuration is employed in view of reliability at fault, the number of the units can be reduced rather than provision of the double configuration in different places. The cost can be reduced.

Signals transmitted from the RF unit are divided by the switch (507) to plural pieces of antenna equipment located physically apart from each other. The divided radio signals are converted to optical signals by the E/O converter (504) to be transmitted via the optical fiber (404) to the antenna equipment (402). In the example of FIG. 5, E/O conversion is performed after dividing the radio signals. The E/O converter (504) may be arranged between the RF unit (508) and the switch (507) to perform signal division to plural pieces of antenna equipment after E/O conversion.

The antenna equipment (402) converts an optical signal to an electric signal by the O/E converter (503) to amplify the signal by the amplifier (502) to radiate an electric wave via the antenna (501).

In FIG. 5, as main features, the line connecting the access point (401) to the antenna equipment (402) and the antenna equipment (403) is an optical fiber, and this line is an optical fiber so that a signal converted to radio frequency is directly transmitted via the optical fiber. In the category of the present invention, the RF units are mounted on the antenna equipment (402) and the antenna equipment (403).

The system configuration shown in FIG. 5 has a high affinity for the configuration of a system called RoF (radio on fiber). The RoF system is one of methods of configuring the access point and the system. The RoF system integrates baseband signal processing into one place, does not perform signal processing about user data by the antenna equipment on the end side, and connects the antenna equipment at the end to the concentration station performing the baseband signal processing via an optical fiber. A basic function necessary for configuring the system can be almost the same as that of FIG. 5. The RoF system is often intended for cost reduction by inexpensive antenna equipment and concentration control. As in this case, phase control of the antennas is necessary to realize MIMO. A new control signal needs to be transmitted to perform cyclic phase control of the antennas as the system. The antenna equipment requires a control function to cyclically perform phase control of the antennas. The baseband unit requires coding for MIMO and division to the antennas.

If signal processing addition for MIMO, control signal addition, control function addition in the antenna equipment can easily respond to update or replacement of software, these may be realized using the same hardware as that of the existing RoF system.

The control signal necessary for realizing MIMO by the access point (401) will be described.

When MIMO is performed on the down line, a training sequence is transmitted from the access point (401) toward the access terminal on the down line. The training sequence is used for estimating the current status of a propagation path on the access terminal (301) and separating and taking out signal intensity and phase information from the antennas and sets, as a system, a known training sequence.

In the MIMO transmission, weight of antenna directivity and an electric power is controlled according to the status of the propagation path. It is desirable that the control signals be cyclically transmitted for each frame of about 10 ms and be suitably updated.

The access terminal can estimate the propagation path based on the training sequence transmitted from the access point (401) and can individually perform a matrix operation of MIMO data based on the result to restore the data. The propagation information estimated by the access terminal such as the training result of the training sequence and the propagation path estimated result transmitted on the down line is transmitted from the access terminal to the access point (401) using a reverse line (here, the up line). The access point (401) decides antenna weight of the next transmitted data based on the feedback information to expect to improve the throughput. In the present invention, the feedback information is transmitted on the up line.

The MIMO system controls antenna directivity and an electric power according to the status of the propagation path. The feedback information signals may be cyclically transmitted for each frame of about 10 ms. Although not shown, the access terminal (301) may store the previously transmitted feedback information and transmit the feedback information signals only when the status of the propagation path is changed more greatly than the feedback information to be transmitted currently, thereby reducing feedback. Alternatively, information whether or not the access terminal is moving may be used to judge whether feedback information needs to be generated and feedback information may be generated only when expecting that the status of the propagation path is greatly changed at moving, thereby reducing feedback.

When MIMO is performed on the up line, a training sequence is transmitted from the access terminal (301) toward the access point on the up line. The training sequence is used for estimating the current status of a propagation path on the access point (401) and separating and taking out signal intensity and phase information from the antennas and sets, as a system, a known training sequence capable of specifying the access terminal.

MIMO controls weight of antenna directivity and an electric power according to the status of the propagation path. It is desirable that the control signals be cyclically transmitted for each frame of about 10 ms and be updated.

The access point can estimate the propagation path based on the training sequence transmitted from the access terminal (301), and can individually perform a matrix operation of MIMO data based on the result to restore the data. The propagation information estimated by the access point such as the training result of the training sequence and the propagation path estimated result transmitted on the up line is transmitted from the access point to the access terminal (301) using a reverse line (here, the down line). The access terminal (301) decides antenna weight of the next transmitted data based on the feedback information to expect to improve the throughput. The feedback information is transmitted on the down line. MIMO controls antenna directivity and an electric power according to the status of the propagation path. The feedback information signals may be cyclically transmitted for each frame of about 10 ms. Although not shown, the access point (401) may store the previously transmitted feedback information and transmit the feedback information signals only when the status of the propagation path is changed more greatly than the feedback information to be transmitted currently, thereby reducing feedback.

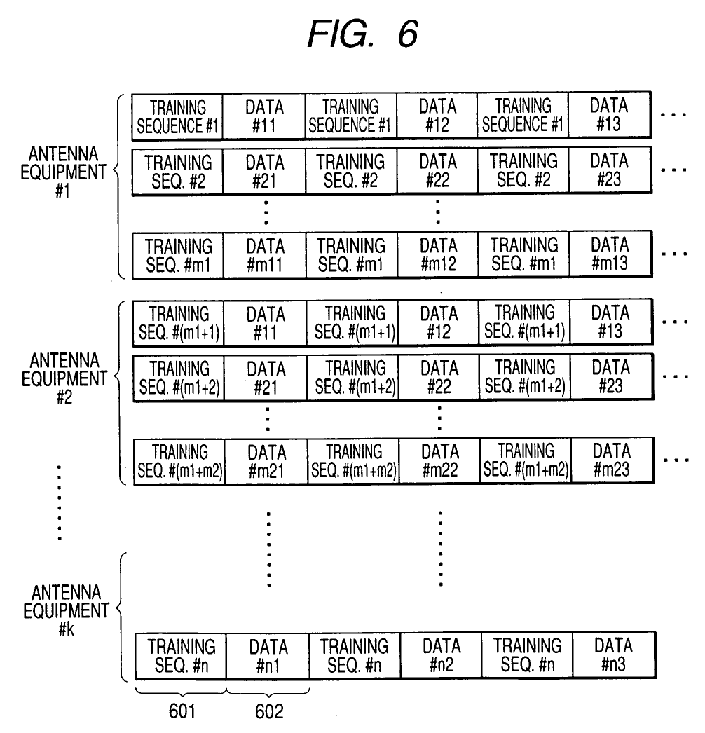

The detail of the training sequences used for estimating the wireless propagation path of signals transmitted from the antennas in the present invention will be described. The access terminal (301) can desirably handle the training sequences for realizing MIMO without depending on whether the training sequences are transmitted from one access point or from plural places physically apart from each other (the respective pieces of antenna equipment), as in the present invention. The training sequences need to be synchronized with the timing transmitted from the antenna equipment (402) and the antenna equipment (403) so that the access terminal can receive them. The signal transmission pattern is shown in FIG. 6. Training sequences (601) transmitted from the antennas of the plural pieces of antenna equipment (402, 403) are received by the access terminal at the same timing. The training sequences maintain the orthogonal relation so as not to affect each other. Specifically, orthogonal codes such as known Walsh codes are associated with the training sequences. In the example of FIG. 6, the reference numeral (601) denotes a training sequence, and the reference numeral (602) denotes a data sequence. As shown in the reference numeral (601), all training sequences are different in all antennas of the plural pieces of antenna equipment (402, 403) accommodated in the access point controller (204). The data sequences (602) to be transmitted are matched with the training sequences so that different data are transmitted to realize high-speed transmission by MIMO.

The training sequences described here assume to use the down line. The up line may be used.

When the access point and the antenna equipment shown in FIG. 5 are used, they are connected via an optical fiber. The transmission time of data between the access point and the antenna equipment can be calculated. The data is transmitted in consideration of the transmission time via the optical fiber and the propagation delay in the wireless section so that the access terminal can receive the orthogonal training sequences at the same time.

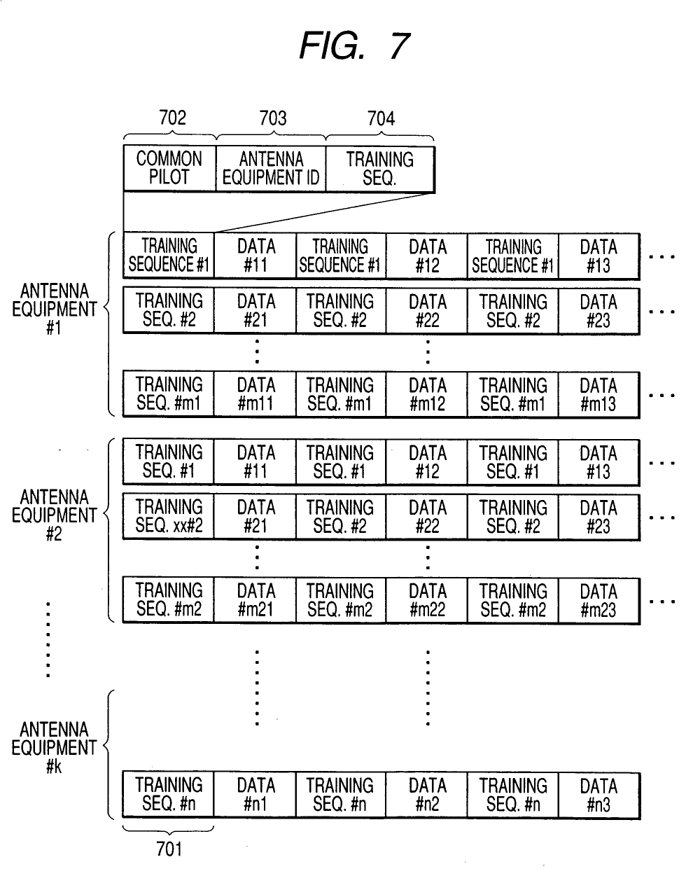

The detail of another example of the training sequences in the present invention will be described. The access terminal need to handle the training sequences for realizing MIMO without depending on whether the training sequences are transmitted from one access point or from plural places physically apart from each other (the respective pieces antenna equipment), as in the present invention. When the access point is an asynchronous system, the timing transmitting the training sequence is different for each piece of the antenna equipment (402, 403). A training sequence (701) shown in FIG. 7 includes a common pilot signal (702) used for detecting timing and an antenna equipment identifier (703) for identifying from which antenna equipment the training sequence is transmitted. Since the antenna equipment identifier (703) exists, in a training pattern (704) different for each antenna for measuring the status of the propagation path, all training sequences need not be different in all antennas of the plural pieces of antenna equipment (402, 403) accommodated in the access point controller (204). A pattern uniquely defined in one piece of antenna equipment may be used by another piece of antenna equipment. In the example of FIG. 7, the common pilot signal (702), the antenna equipment identifier (703), and the training pattern (704) are configured in time multiplex and may be realized by code multiplex. The common pilot signal (702) may be independently transmitted as another channel without being multiplexed.

The data sequence transmitted is matched with the training sequence so that different data are transmitted to realize high-speed transmission by MIMO.

According to the method of transmitting the training sequence, all antennas of all pieces of antenna equipment include a common pilot signal, which can be utilized for synchronization and detection on the access terminal.

The transmitter configuration of the access point corresponding to the configuration transmitting the training sequences of FIG. 6 on the down line will be described.

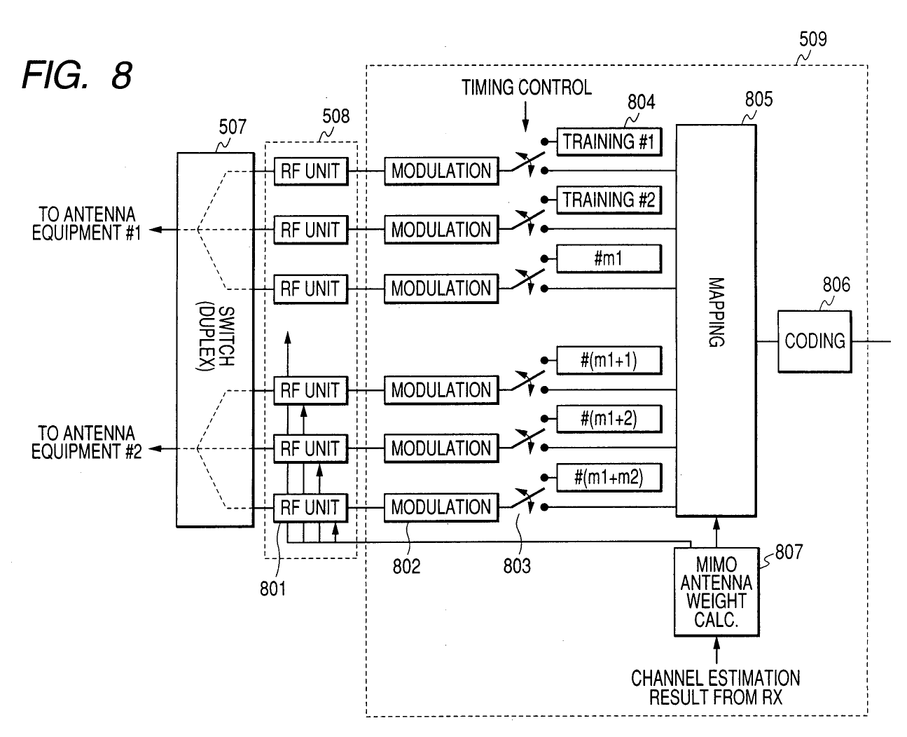

The access point (401) performs signal transmission on both the down line and the up line and has a transmitter on the down line and a receiver on the up line. The configuration of the transmitter on the down line will be described here in detail using FIG. 8.

The transmitter has the baseband unit (509) including a coder (806), a MIMO antenna weight calculation unit (807), a mapping unit (805) performing mapping of a data sequence based on the calculated result of the weight calculation unit, a training sequence generator (804) necessary for realizing MIMO, a switch (803) for multiplexing the training sequence and the data sequence, a modulator (802) modulating multiplexed data, RF units (801, 508) converting modulated data to radio signals, and the switch (507) for dividing radio signals to the antenna equipment (402) and the antenna equipment (403).

Data to be transmitted is subjected to the coding (806) such as a convolution code or a turbo code. MIMO antenna weight is performed from the received channel estimation information (807) for performing mapping to specify antenna equipment, its antenna, and information transmitted (805). The received channel estimation information includes an eigenvalue or an eigenvector of the propagation path. The mapped signals and the training sequences (804) different for the respective antennas are time multiplexed (803), and are modulated (802), and are converted to radio signals in the RF unit (801). MIMO need to control in detail information to specify an antenna for transmission and to specify an antenna, an electric power, and a phase for transmission. A control signal is connected from the weight unit (807) to the RF unit (801). To perform control different for each antenna, in the example of FIG. 8, the RF unit is prepared for each antenna. Baseband signals for plural antennas which are previously multiplexed may be converted to radio signals together. The switch (507) performs multiplexing of the radio signals and division thereof to the respective pieces of antenna equipment.

In FIG. 8, the coding unit (806), the modulation unit (802), and the weight unit (805) performing MIMO control are described in different function blocks. They need not be separate. In applying a modulation method performing coding and modulation at the same time such as a coding modulation method such as space time coding and Trellis code, these pieces of processing are performed together as one function block.

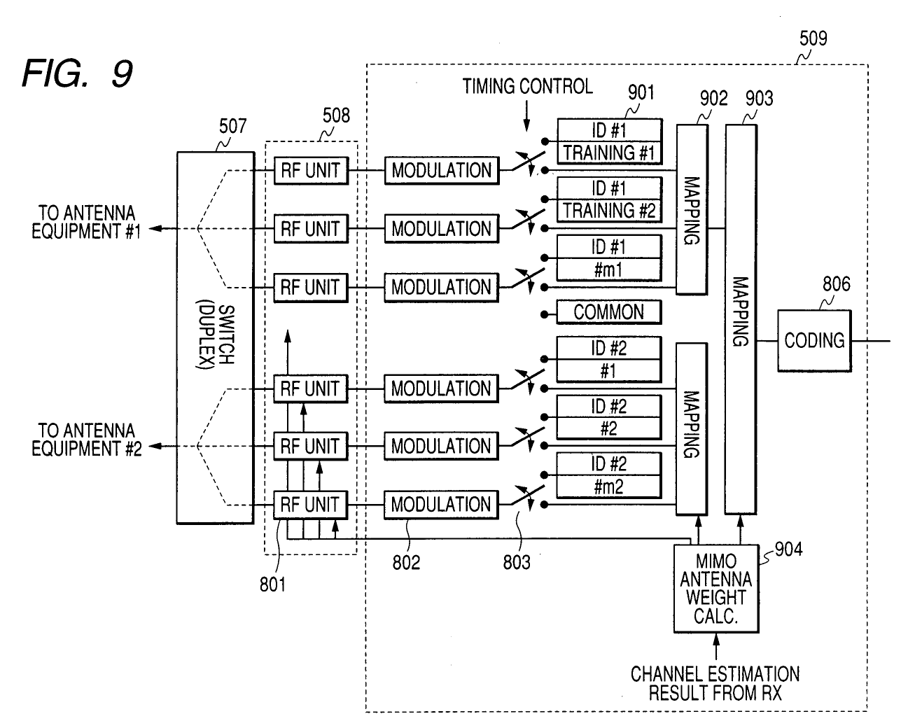

The transmitter configuration of the access point corresponding to the configuration transmitting the training sequences of FIG. 7 on the down line will be described using FIG. 9.

The transmitter has the baseband unit (509) including the coder (806), a MIMO antenna weight calculation unit (904), a mapping unit (903) performing mapping of the antenna equipment based on the calculated result of the weight calculation unit, a mapping unit (902) performing mapping of the antennas in the antenna equipment, a training sequence generation unit (901) to which an identifier of the antenna equipment is added, the switch (803) for multiplexing the training sequence and the data sequence, and the modulator (802) modulating multiplexed data, the RF units (801, 508) converting modulated data to radio signals, and the switch (507) for dividing radio signals to the antenna equipment (402) and the antenna equipment (403).

The transmitter configuration corresponding to the training sequences of FIG. 7 is different from the transmitter configuration corresponding to the training sequences of FIG. 6 in that the time multiplexed training sequence (804) includes the antenna equipment identifier, and that the transmitter configuration of FIG. 7 has the function of controlling specification of antenna equipment weighted by the MIMO antenna weight calculation unit (904) or specification of antenna equipment, its antenna, and weight (902). MIMO needs to control an electric power and a phase in addition to specification of an antenna for transmission. A control signal is connected from the weight calculation unit (904) to the RF unit (801). To perform control different for each antenna, in the example of FIG. 9, the RF unit is prepared for each antenna. Baseband signals for plural antennas which are previously multiplexed may be converted to radio signals together. The switch (507) performs multiplexing of the radio signals and division thereof to the respective pieces of antenna equipment.

The receiver configuration of the access point corresponding to the configuration transmitting the training sequences of FIG. 6 on the up line will be described.

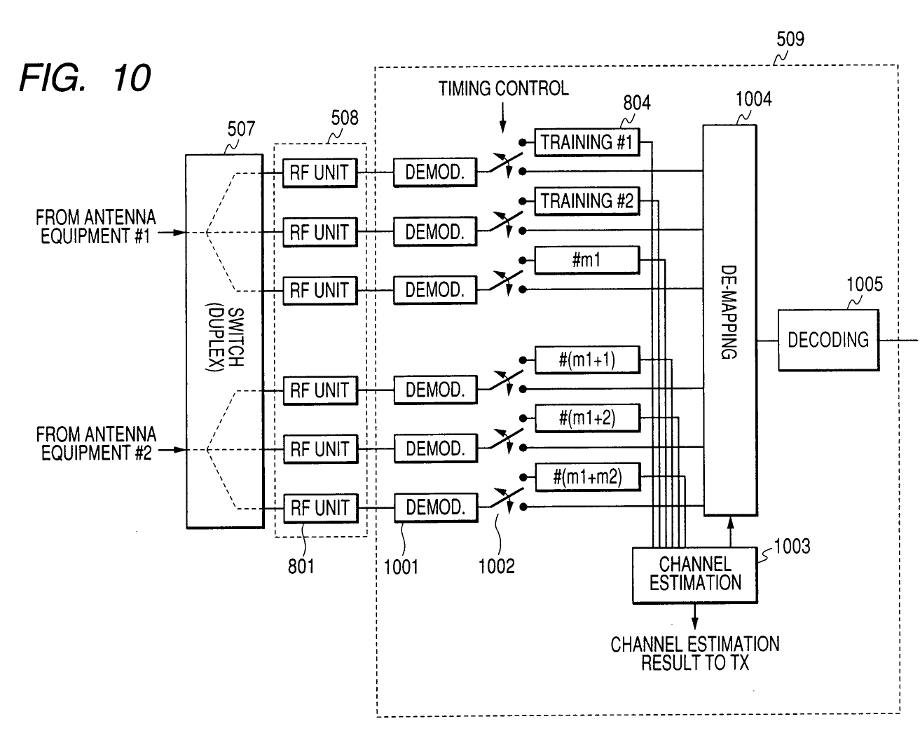

The access point (401) performs signal transmission on both the down line and the up line and has a transmitter on the down line and a receiver on the up line. The configuration of the receiver on the up line will be described here in detail using FIG. 10.

The receiver has the switch (507) separating multiplexed signals received by the respective pieces of antenna equipment, the RF unit (508) converting radio signals to baseband signals, and the baseband unit (509) including a demodulator (1001), a switch (1002) switching and separating the multiplexed training sequence (804) and the data sequence, a channel estimation unit (1003), a de-mapping unit (1004) restoring mapping of a MIMO data sequence, and a decoder (1005).

Signals received by the respective pieces of antenna equipment are subjected to O/E conversion, are inputted as radio signals to the switch (507), and are divided into signals from the antennas. The signals from the antennas are converted to baseband signals by the RF units (801) and are demodulated by the demodulator (1001) to extract the training sequence data of the antennas from the time multiplexed demodulated data (1002) and to transmit information of these values and an electric power to the channel estimation unit (1003). The channel estimation unit (1003) estimates the current propagation information based on the information such as the values and an electric power from the antennas of the respective pieces of antenna equipment, and restores and decodes the information based on the result (1005). The estimated propagation information is transmitted to the transmission unit of the access point to be reflected to a transmission method of data transmitted next time.

In FIG. 10, the demodulation unit (1001), the decode unit (1005), and the weight unit (1004) restoring MIMO are described in different function blocks. They need not be separate. In applying a coding modulation method such as space time coding and Trellis code, these pieces of processing are performed together as one function block.

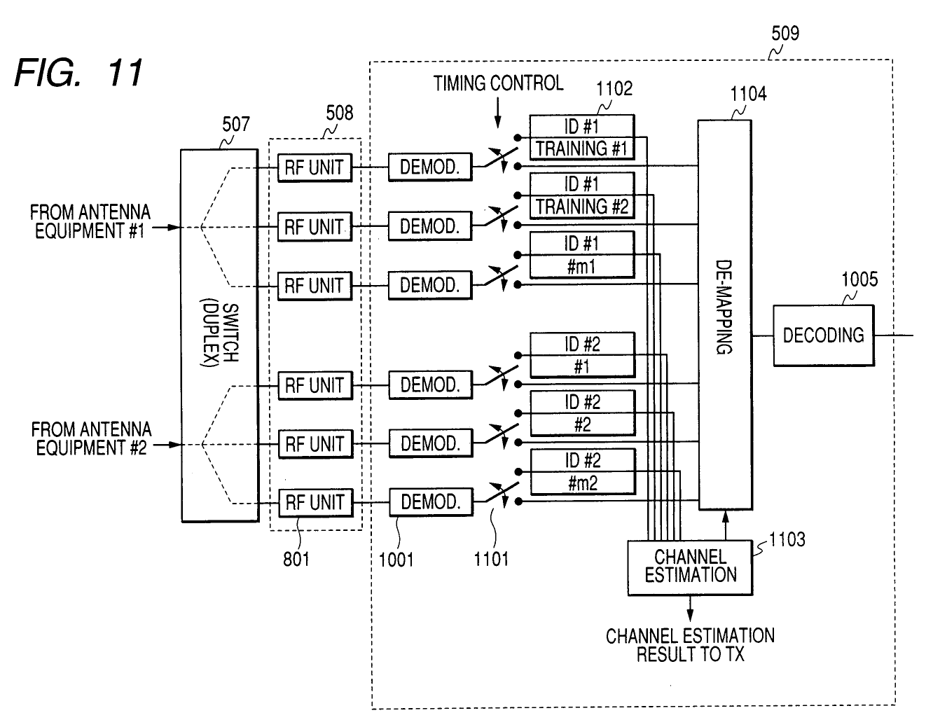

The receiver configuration of the access point corresponding to the configuration transmitting the training sequences of FIG. 7 on the up line will be described using FIG. 11.

The receiver has the switch (507) separating multiplexed signals from the respective pieces of antenna equipment, the RF unit (508) converting radio signals to baseband signals, a demodulator, a training sequence (1102) multiplexed with an identifier of the antenna equipment, a switch switching and isolating data sequences, a channel estimation unit (1103), a de-mapping unit (1104) restoring mapping of a MIMO data sequence, and the decoder (1005).

The receiver configuration corresponding to the training sequences of FIG. 7 is different from the receiver configuration corresponding to the training sequences of FIG. 6 in that the time multiplexed training sequence (1102) includes an antenna equipment identifier; that, with this point, the channel estimation information is calculated; and that the de-mapping unit (1104) of MIMO specifies antenna equipment and its antenna to be controlled. In the example of FIG. 11, the switch (507) converts signals divided to the antennas to baseband signals. The RF unit is prepared for each antenna. Baseband signals for plural antennas which are converted together to radio signals may be divided to be signals of the respective antennas.

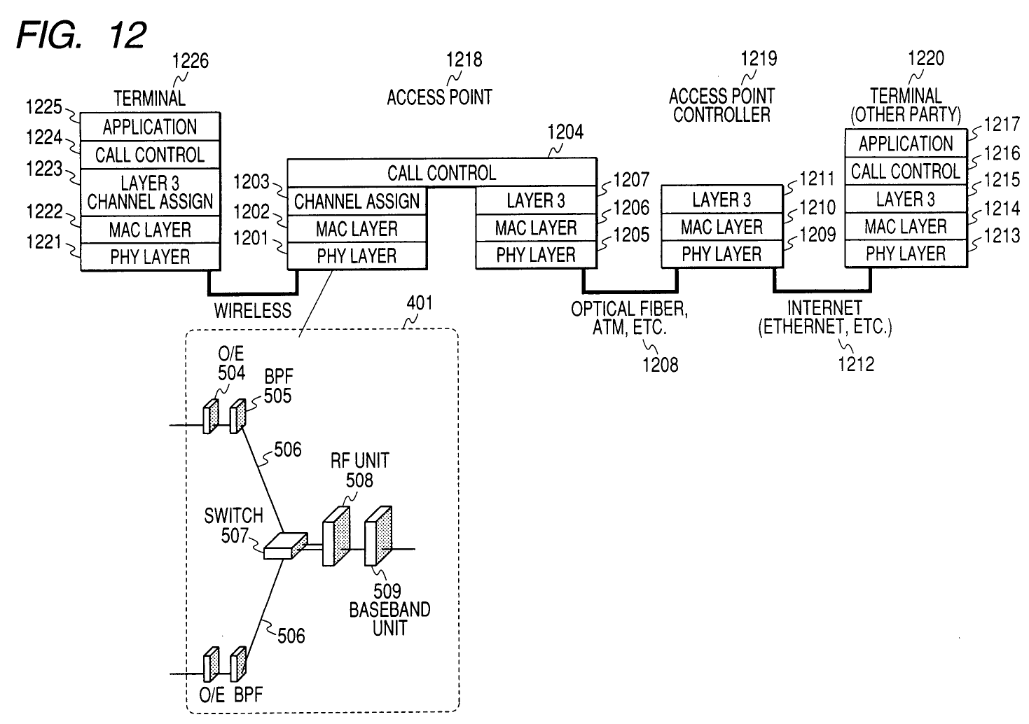

The access point (401) described in FIG. 5 focuses on the flow of data. To clarify in which hierarchical structure call control is performed, hierarchical structures of the units will be described here in detail using FIG. 12.

The hierarchical structures here are described with reference to a physical layer (a first layer), a MAC layer (a second layer), and a network layer (a third layer), which are defined by the general OSI reference model. The physical layer is a hierarchy defining an interface when transmitting data and defines a wireless transmission method, a modulation method, and a frame format. The method of inserting the training sequence of FIGS. 6 and 7 for MIMO in the present invention is defined by the physical layer. The MAC (media access control) layer decides a transmission speed and performs re-transmission control in order that a frame to be transmitted by the physical layer can be properly transmitted and received. The MAC layer decides antenna equipment, its antenna, and weight for transmission to realize MIMO in the present invention. The network layer (a third layer) performs re-transmission control and routing for each IP data using IP data having a data sequence and a header transmitted and received by the physical layer as one processing unit.

An access point (1218) corresponding to the access point (401) has, to perform connection to the access terminal, a physical layer (1201), a MAC layer (1202), a channel allocation layer (1203), and a call control layer (1204) performing call control, and to perform connection to an access point controller (1219), a physical layer (1205), a MAC layer (1206), and a third layer (1207) for performing connection to the network side. The names of the channel allocation layer (1203) and the call control layer (1204) are not defined by the OSI reference model and are clearly descried for description. The channel allocation layer (1203) is a hierarchy mainly managing allocation and release of channels on the wireless channel and update of channels at handover. The call control layer (1204) is almost an application layer and handles call control such as transmission and reception of data communication. The application layer defines an application such as browsing of Web, transmission and reception of mail, and download of files.

The access point controller (1219) has, as an interface for connecting to the access point (1218) and the outside such as the Internet, a physical layer (1209), a MAC layer (1210), and a third layer (1211).

A terminal of other party and server (1220) has, as an interface for connecting to the access point controller (1219) and the Internet, a physical layer (1213), as hosts thereof, a MAC layer (1214), a third layer (1215), a call control layer (1216), and an application layer (1217) for communication.

The access point controller (1219) serves as a router supporting routing and network communication with other party (1220).

A terminal of other party (1226) has the same hierarchical structure as that of the terminal of other party and server (1220), has a wireless physical layer (1221) as an interface connecting to the access point, and has, as hosts thereof, a MAC layer (1222), a channel allocation layer (1223), a call control layer (1224), and an application layer (1225) for communication.

The access point (1218) need to perform data communication with the access point controller (1219) and communication with the access terminal and has two interfaces (1201, 1205) as the physical layers. In the feature of the present invention, when plural pieces of antenna equipment are accommodated for performing MIMO, wireless channel controls including wireless channel establish and wireless channel allocation and release are performed together by the access point (1218). The processing related to MIMO is terminated on the access point. The access point controller (1219) and the terminal of other party and server (1220) need not be conscious of whether MIMO is performed or not.

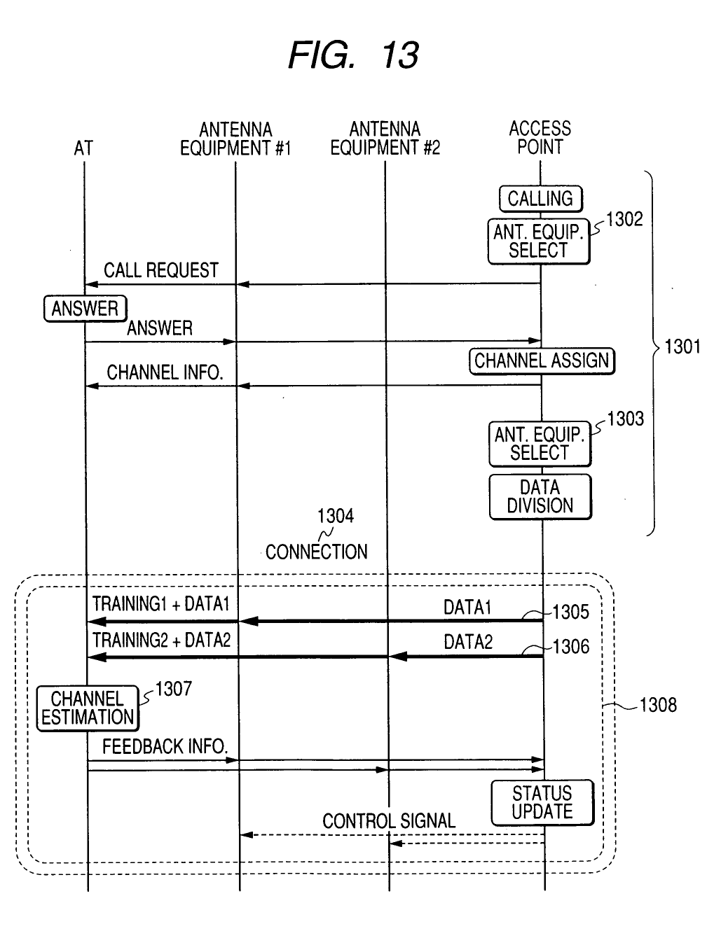

The control flow in the present invention is shown in FIG. 13 by taking reception on the access terminal as an example.

The access point (401) selects one piece of antenna equipment to which an access terminal belongs (1302). Antenna equipment closest to the access terminal is selected from antenna equipment in an active set (a collection of antenna equipment near the access terminal), that is, antenna equipment judged to have the highest reception electric power on the access terminal is selected. The active set concept has already been used in a cellular system typified by 3GPP2 (3rd Generation Partnership Project 2) and is originally a table managing every moment the status of the access point around the access terminal matched with the identifier of the access point to easily perform handover. Here, the active set is defined as a collection of antenna equipment near the access terminal. When performing MIMO, an antenna used for MIMO is selected from antenna equipment included in the active set.

A Call Request signal that there is a reception request to the access terminal (301) via one selected piece of antenna equipment. The access terminal in which reception can be done transmits an answer of Call Request to the access point (401). When receiving, from the access terminal, information that reception can be done, the access point (401) performs wireless channel assign for communicating with the access terminal and transmits information on a channel used to the access terminal (301) again. The access terminal in which reception cannot be done does not transmit an answer to the access point or transmits thereto an answer that reception cannot be done. The access point terminates communication as impossible reception without performing channel assign processing.

In the control flow, processing (1301) performs communication without performing MIMO. Assuming that plural pieces of antenna equipment in the active set are used to perform MIMO, the plural pieces of antenna equipment performing MIMO processing are selected (1303) to assign data to the antennas. Data given the orthogonal training sequences are transmitted from the respective pieces of antenna equipment (1305, 1306). The result of a training (1307) on the access terminal is returned as feedback information to the access point (401). The access point (401) decides weight to antennas of the data sequence transmitted at the next timing based on the feedback information. The processing (1308) is repeated to realize MIMO using the plural pieces of antenna equipment. In this example, two data sequences transmitted in parallel from the antennas are shown. The number of data sequences is not limited to two. The number of pieces of antenna equipment is not limited. The data sequences given the corresponding training sequences are transmitted in parallel to the plural antennas of the plural pieces of antenna equipment according to the number of pieces of antenna equipment included in the active set and the status of the propagation path.

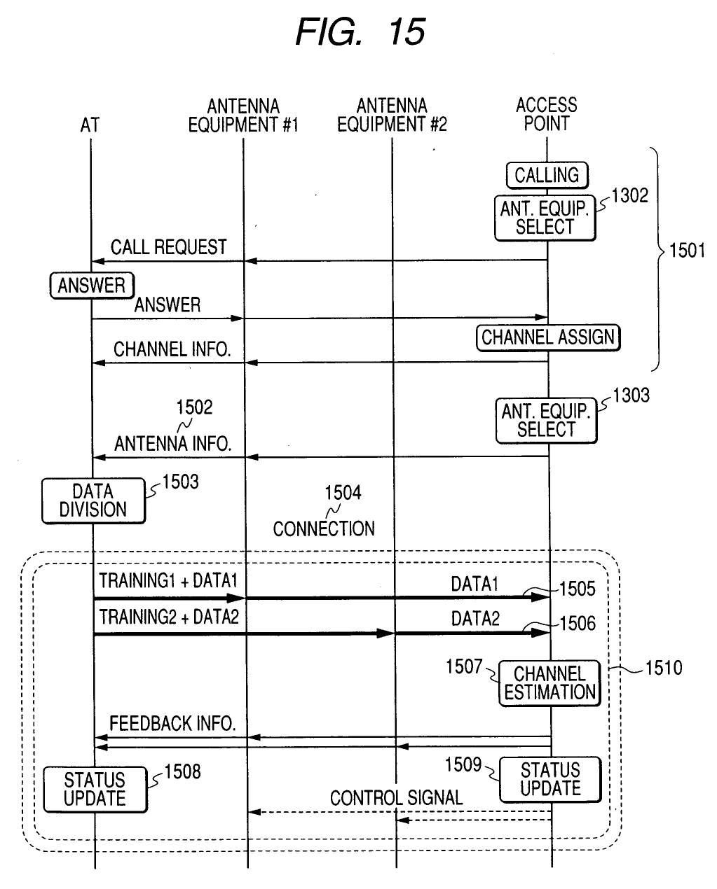

After the reception to the access terminal, the control flow when performing MIMO on the up line is shown in FIG. 15. Processing for establishing a call (1501) is the same as that of FIG. 13. Assuming that the access terminal transmits MIMO data, the access point selects the antenna equipment to receive data by the plural pieces of antenna equipment (1303), and notifies the information to the access terminal (1502). The information is used for deciding whether MIMO is performed on the access terminal or the number of parallel transmissions when performing MIMO. Data to be transmitted in the reference numeral (1503) using the information are assigned to plural antennas of its own station to transmit data sequences (1505, 1506).

The antenna equipment does not identify antenna equipment to which data is transmitted, and directly transmits the received data sequence to the access point. The access point takes out a reception signal from the access terminal for performing channel estimation (1507) and restoring MIMO data. The access point transmits the propagation estimated result as feedback information to the access terminal. The access terminal updates weight of an antenna transmitting the next data. The feedback information transmitted to the access terminal may be transmitted from one piece of antenna equipment or may be transmitted from plural pieces of antenna equipment performing MIMO, thereby improving reception quality on the access terminal. When the active set is updated along with movement of the access terminal, the antenna equipment to receive it is updated. In order that the antenna equipment can easily receive information from the access terminal, updating of the antenna equipment including control directing of the directivity toward the access terminal is performed using a control signal to the respective pieces of antenna equipment. When a signal received by the antenna equipment is only transmitted directly to the access point, the control signal need not be used. Processing (1510) is repeated to realize MIMO on the up line.

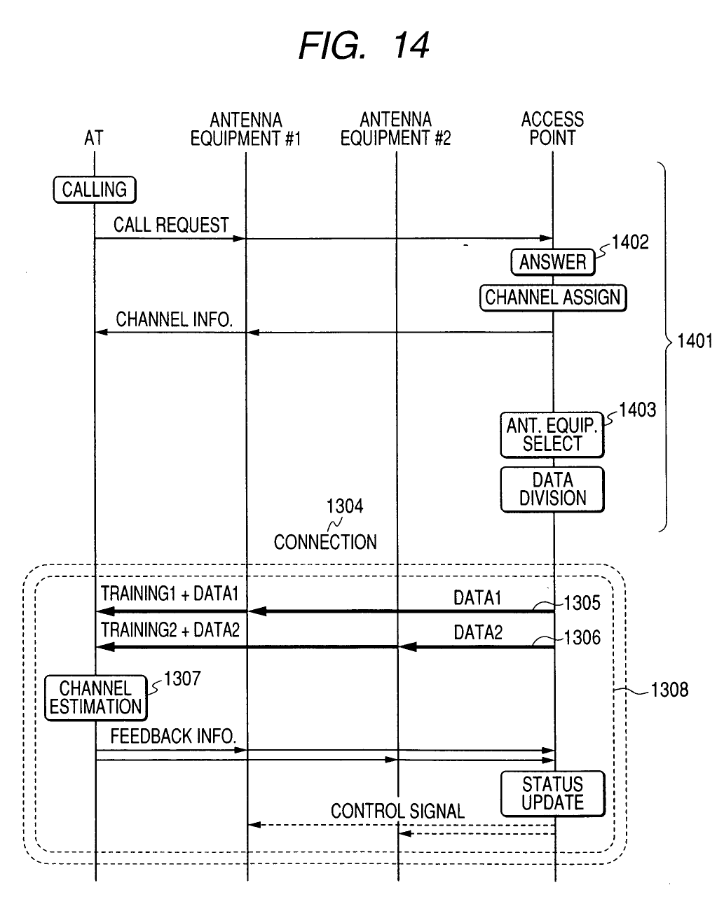

FIG. 14 shows a control flow in the present invention by taking establish of a call transmitted from the access terminal to perform MIMO on the down line, as an example. The access terminal (301) transmits a call request. A signal which has received an electric wave from the access terminal including the call request is decoded by the access point (403) via any one piece of antenna equipment to search for an available channel on the down line. When there is an available channel, the down line is assigned (1402) to notify it to the access terminal.

Assuming that plural pieces of antenna equipment in an active set are used on the down line to perform MIMO, plural pieces of antenna equipment performing MIMO are selected (1403) to assign data to the antennas. The data given the orthogonal training sequences are transmitted from the respective pieces of antenna equipment (1305, 1306). The result of the training (1307) on the access terminal is returned as feedback information to the access point (401). The access point (401) decides weight to antennas of the data sequences transmitted at the next timing based on the feedback information. The processing (1308) is repeated to realize MIMO using plural pieces of antenna equipment. In this example, two data sequences transmitted in parallel from the antennas are described. The number of data sequences is not limited to two. The number of pieces of antenna equipment is not limited. The data sequences given the corresponding training sequences are transmitted in parallel to plural antennas of plural pieces of antenna equipment according to the number of pieces of antenna equipment included in the active set and the status of the propagation path.

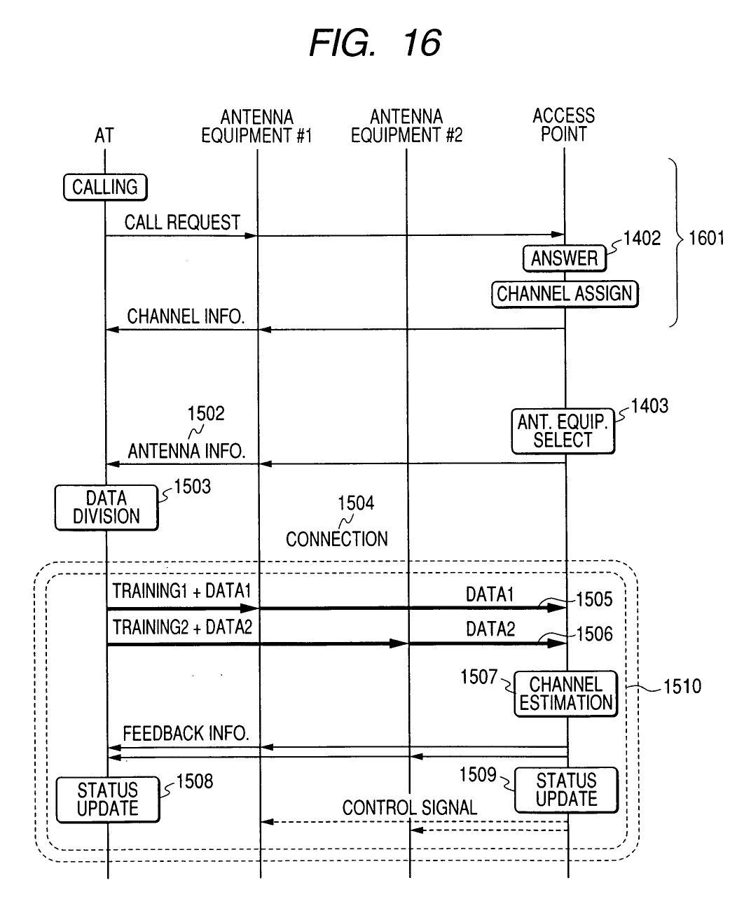

FIG. 16 shows a control flow for performing MIMO on the up line after the transmission from the access terminal. Processing for establishing a call (1601) is the same as that of FIG. 14. Assuming that the access terminal transmits MIMO data, the access point selects the antenna equipment (1403) to receive data by the plural pieces of antenna equipment, and notifies the information to the access terminal (1502). The information is used for deciding whether MIMO is performed on the access terminal or the number of parallel transmissions when performing MIMO. Data to be transmitted in the reference numeral (1503) using the information are assigned to plural antennas to transmit data sequences (1505, 1506). The antenna equipment does not identify antenna equipment to which data is transmitted, and directly transmits the received data sequence to the access point. The access point performs channel estimation (1507) and restoring MIMO data. The access point transmits the propagation path estimated result as feedback information to the access terminal. The access terminal updates weight of an antenna transmitting the next data. The feedback information transmitted to the access terminal may be transmitted from one piece of antenna equipment or may be transmitted from plural pieces of antenna equipment performing MIMO, thereby improving reception quality on the access terminal. When the active set is updated along with movement of the access terminal, the antenna equipment to receive it is updated. In order that the antenna equipment can easily receive information from the access terminal, updating of the antenna equipment including control directing of the directivity toward the access terminal is performed using a control signal to the respective pieces of antenna equipment. When a signal received by the antenna equipment is only transmitted directly to the access point, the control signal need not be used. The processing (1510) is repeated to realize MIMO on the up line.

The present invention can be mounted on a fourth-generation cellular phone and an access point in a wireless communication system and can be embodied as a system for improving spectral efficiency.

1. A wireless communication system including an access point and an access terminal, wherein the access terminal has plural antennas and a baseband unit, the access point has plural pieces of antenna equipment located geographically apart from each other and each having one or more antennas and a baseband unit connected to said plural pieces of antenna equipment, so that the plural antennas of said plural pieces of antenna equipment transmit and receive a transmission/reception signal signal-processed by said baseband unit to perform MIMO communication with the plural antennas of said access terminal.

2. The wireless communication system according to claim 1,
wherein the baseband unit and said plural pieces of antenna equipment of said access point are connected via an optical fiber,
wherein the baseband unit of said access point has an amplifier amplifying a reception signal received by said plural pieces of antenna equipment and a transmission signal, an electrical/optical converter converting the transmission signal transferred to said antenna equipment from an electric signal to an optical signal, and an optical/electrical converter converting the reception signal received by said antenna equipment from an optical signal to an electric signal.

3. The wireless communication system according to claim 1, wherein for MIMO communication, the baseband unit of said access point transmits a control signal controlling at least directivity of the antennas of said plural pieces of antenna equipment, the respective pieces of antenna equipment of said access point transmit different training sequences to said access terminal, and said access terminal transmits propagation information including the training result of the training sequences to said access point.

4. The wireless communication system according to claim 3, wherein said training sequences are all different in the antennas of said plural pieces of antenna equipment, and the patterns of the training sequences are in low correlation.

5. The wireless communication system according to claim 3, wherein said training sequences are all different in the plural antennas in one piece of antenna equipment, and the patterns are in low correlation.

6. The wireless communication system according to claim 1, wherein wireless channel assign is performed by the access point.

7. An access point in a wireless communication system in which an access terminal and an access point perform MIMO communication, comprising:
plural pieces of antenna equipment located geographically apart from each other and each having one or more antennas; and
a baseband unit connected to said plural pieces of antenna equipment,
wherein the plural antennas of said plural pieces of antenna equipment transmit and receive a transmission/reception signal signal-processed by said baseband unit to perform MIMO communication with plural antennas of said access terminal.

8. The access point according to claim 7,
wherein said baseband unit and said plural pieces of antenna equipment are connected via an optical fiber,
wherein said baseband unit has an electrical/optical converter converting the transmission signal transferred to said antenna equipment from an electric signal to an optical signal, and an optical/electrical converter converting the reception signal received and transferred by said antenna equipment from an optical signal to an electric signal.

9. The access point according to claim 7, wherein for MIMO communication, said baseband unit controls directivity of the antennas of said plural pieces of antenna equipment, transmits training sequences to said access terminal via said plural pieces of antenna equipment, and receives propagation information including the training result from said access terminal via at least any one of said plural pieces of antenna equipment.

10. The access point according to claim 9, wherein said training sequences are all different in the antennas of said plural pieces of antenna equipment, and the patterns of the training sequences are in low correlation.

11. The access point according to claim 9, wherein said training sequences are all different in the plural antennas in one piece of antenna equipment, and the patterns are in low correlation.

12. The access point according to claim 7, further comprising one or more coders, plural modulators, a block generating a training sequence different for each antenna, a switch switching said training sequence and a data sequence, plural radio frequency units, a block calculating weight for transmission by MIMO communication, and a mapping unit performing weight to each antenna.

13. The access point according to claim 7, wherein a common pilot signal for transmitting identical signals from said plural pieces of antenna equipment and identifier capable of uniquely defining each piece of antenna equipment are transmitted.

14. The access point according to claim 6, further comprising one or more decoders, plural demodulators, a block decoding a training sequence different for each antenna, a switch switching said training sequence and a data sequence, plural radio frequency units, a channel estimation unit, and a block restoring the data sequence received by a MIMO communication method.

15. The access point according to claim 413, wherein a common pilot signal for transmitting identical signals from the plural pieces of antenna equipment and identifier capable of uniquely defining each piece of antenna equipment are received and decoded to perform channel estimation of each antenna.

16. A communication method in a wireless communication system including an access terminal having plural antennas and a baseband unit, and an access point having plural pieces of antenna equipment located geographically apart from each other and each having one or more antennas and a baseband unit connected to said plural pieces of antenna equipment,
wherein said baseband unit of said access point performs baseband processing of transmission signals to one said access terminal, divides and transmits the transmission signals subjected to said baseband processing to said plural pieces of antenna equipment, and transmits said transmitted transmission signals from said plural pieces of antenna equipment to said access terminal by MIMO communication.

17. The communication method according to claim 16, wherein at reception on said access terminal or connection establish from said access point to the access terminal, MIMO communication is not performed, communication with the antenna equipment in the best status communicated with said access terminal is performed to establish at least one or more wireless channels, and after wireless channel establish, said plural pieces of antenna equipment are used to perform MIMO communication.

18. The communication method according to claim 16, wherein at transmission from said access terminal or connection establish from said access terminal to the access point, MIMO communication is not performed, communication with the antenna equipment in the best status communicated with said access terminal is performed to establish at least one or more wireless channels, and after wireless channel establish, said plural pieces of antenna equipment are used to perform MIMO communication.
